(19) United States
(12) Patent Application Publication
(10) Pub. No.: US 2022/0357188 A1
(43) Pub. Date: Nov. 10, 2022

(54) Venturi Flowmeter Including a Dynamically Variable Effective Constriction Ratio

(71) Applicant: Brown Hawk Technologies, LLC, Santa Barbara, CA (US)

(72) Inventors: Christopher Joseph Brown, Santa Barbara, CA (US); Najmeh Brown, Santa Barbara, CA (US)

(73) Assignee: Brown Hawk Technologies, LLC, Santa Barbara, CA (US)

(21) Appl. No.: 17/314,918

(22) Filed: May 7, 2021

(51) Int. Cl. G01F 1/44; G01F 15/00

(52) U.S. Cl. CPC G01F 1/44; G01F 15/005

(57) ABSTRACT

A flowmeter may include an inlet configured to couple to a first conduit to receive a flow of a multiphase medium, an outlet configured to couple to a second conduit to deliver the multiphase medium, and a chamber extending between the inlet and the outlet and providing a flow path between the inlet and the outlet. The flowmeter may include a device within the chamber. The device may be configured to move in response to the multiphase medium to dynamically vary an effective constriction ratio of the flow path. The flowmeter may include a circuit configured to determine a flow rate of the multiphase medium based on the effective constriction ratio.

### FIELD

The present disclosure is generally related to flowmeters, such as Venturi flowmeters, and more particularly to Venturi flowmeters that define a flow path having a dynamically variable effective constriction ratio to determine flow rate data across a wide range of flow rates.

### BACKGROUND

Accurate measurement of flow rate of crude oil mixtures (oil, gas, water, and debris) in a pipeline has been one of the biggest challenges facing the oil industry. Historically, the crude mixture may be separated so that multiple metering devices can be used to measure the flow rate during a sampling period, and then the volume and flow rate may be estimated based on the initial sampling period.

To accurately measure gas and oil production (for example, plus or minus five percent error or ninety-five percent accuracy), a field operator may have to separate oil, water, gas, and solid contaminants into single-phase components using large production separators, and then each component of the medium may be measured separately using conventional single-phase flowmeters. Such single-phase flowmeters, such as orifice plates, Venturi tubes, Coriolis flowmeters, ultrasonic flowmeters, turbine flowmeters, and other flowmeters, may accurately measure a single phase within a predefined range once the phases are adequately separated.

Test separators have traditionally been used to determine the oil, gas, and water output from an individual well on a periodic basis. Such separators are typically large and can be moved from location to location, rotated from well to well, or any combination thereof to perform periodic measurements. However, such measurements disrupt normal operations, and may require flowline rerouting through the separator. Conventionally, such measurements by single-phase or non-multiphase flowmeters are relied upon to estimate the cut. However, such measurements are typically periodic with large amounts of time between measurement periods because the device has been rotated out to measure other wells. As a consequence of periodic measuring, during periods when the fluid mixture is not measured, the production decline and the associated cut become estimates between measurement periods.

In some instances, the flowline may be routed to a conventional single-phase flowmeter to measure a flow rate. Conventional single-phase flowmeters may experience numerous issues when placed in a multiphase environment. Such issues may include twisting or movement of the device, wear of the device or its components, clogging and other related performance issues, or any combination thereof, providing a limited performance life and requiring frequent service and recalibration. Additionally, conventional single-phase flowmeters may experience performance issues when the flow rate varies over a wide range during short intervals.

### SUMMARY

Embodiments of a Venturi flowmeter are described below that may define an effective constriction ratio that varies dynamically during operation in response to a multiphase medium to provide accurate flow rate data across a wide range of flow rates. In some implementations, the Venturi flowmeter may include an inlet, an outlet, and a chamber defining a flow path between the inlet and the outlet. The chamber may include a device, which may be configured to move in response to the multiphase medium, varying an effective constriction ratio between an effective diameter of the chamber and a diameter of one of the inlet or the outlet. The variable Venturi flowmeter may include a pressure sensor to determine pressure data associated with the fluid mixture in the chamber and a second sensor to determine second data associated with a parameter of the device in the chamber. The second data may be indicative of one or more of a displacement, a position, an orientation, or a volume of the device. The assembly may be configured to measure a flow rate of a multiphase medium including oil, water, entrained gas, and contaminants as a function of the pressure data and the second data.

In some implementations, the Venturi flowmeter with the dynamically variable effective constriction ratio may be constructed using an existing device that may already provide a function in a fluid flow context, such as a valve. The valve functions may be to limit, restrict, or cease fluid flow or may be designed to limit flow to a single direction (such as a check valve). The device may be implemented as a valve component or valve member, such as a plurality of moveable blades of an iris valve, a ball member of a ball valve, a flapper or swing member of a swing valve, a piston member of a valve, or a check disk mounted to the flapper member or the piston member. The valve component may be biased toward a closed state.

The valve implementation of the Venturi flowmeter may include an inlet, an outlet, a chamber that extends between the inlet and the outlet, and a valve member within the chamber. The valve member may be biased toward a valve seat (such as by a spring or other mechanical component) to close the fluid flow path, and the valve seat may form the throat of the constriction within the chamber. The multiphase medium may cause the valve member to move away from the valve seat. In such an implementation, the valve member moves passively in response to the pressure of the multiphase medium, narrowing the constriction in response to reduced flow and reduced pressure and widening the constriction in response to increased flow and increased pressure, providing a dynamically variable effective constriction ratio between the diameter of the inlet and an effective cross-sectional diameter of the constriction. A pressure sensor may determine a pressure of the multiphase medium in the chamber and a second sensor may determine one or more of a displacement, a position, or an orientation of the valve member. The flow rate may be determined based on the pressure and one or more of the displacement, the position, or the orientation. In some implementations, the valve may also perform its valve functionality.

In some implementations, the flowmeter may include a circuit including or coupled to the pressure sensor and the second (position) sensor. The circuit may include a processor configured to receive pressure data from the pressure sensor and second data (one or more of displacement data, position data, or orientation data) from the second sensor. The circuit may also include an interface coupled to the processor and configured to send data to and receive data from a computing device. In some implementations, the circuit may determine flow rate data based on the pressure data and the second data and may send the flow rate data to the computing device. In other implementations, the circuit may send the pressure data and the second data to the computing device, and the computing device may determine the flow rate data. The computing device may provide a graphical interface indicating that includes the flow rate data.

In some implementations, an apparatus may include a variable Venturi flowmeter. The variable Venturi flowmeter may include an inlet configured to couple to a first conduit to receive a fluid (such as a multiphase mixture), an outlet configured to couple to a second conduit to deliver the fluid, and a chamber extending between the inlet and the outlet and providing a flow path between the inlet and the outlet. The variable Venturi flowmeter may include a device within the chamber. The device may be configured to move to alter an effective constriction ratio of the flow path in response to the fluid. The variable Venturi flowmeter may include a circuit including a pressure sensor to determine pressure data associated with the chamber, a second sensor to determine one or more parameters (one or more of a displacement, a position, or an orientation) associated with the device, and a processor to determine a flow rate of the fluid based on the pressure data and the one or more parameters.

In some implementations, a flowmeter may include an inlet configured to couple to a first conduit to receive a flow of a multiphase medium, an outlet configured to couple to a second conduit to deliver the multiphase medium, and a chamber extending between the inlet and the outlet and providing a flow path between the inlet and the outlet. The flowmeter may include a device within the chamber. The device may be configured to move in response to the multiphase medium to dynamically vary an effective constriction ratio of the flow path. The flowmeter may include a circuit configured to determine a flow rate of the multiphase medium based on the effective constriction ratio.

In other implementations, a flowmeter may include an inlet, an outlet, and a chamber extending between the inlet and the outlet. The inlet may have a first cross-sectional diameter and may be configured to couple to a first conduit having the first cross-sectional diameter to receive a flow of a multiphase medium. The outlet may have the first cross-sectional diameter and may be configured to couple to a second conduit having the first cross-sectional diameter to deliver the multiphase medium. The chamber may have a second cross-sectional diameter and may be configured to provide a flow path between the inlet and the outlet. The flowmeter may include a device within the chamber that is configured to move in response to the multiphase medium to dynamically vary an effective cross-sectional area of the chamber and an effective constriction ratio of the flow path. The flowmeter may include a circuit configured to determine a flow rate of the multiphase medium based on the effective constriction ratio.

In still other implementations, a flowmeter may include an inlet, an outlet, and a chamber extending between the inlet and the outlet. The inlet may have a first cross-sectional diameter and may be configured to couple to a first conduit having the first cross-sectional diameter to receive a flow of a multiphase medium. The outlet may have the first cross-sectional diameter and may be configured to couple to a second conduit having the first cross-sectional diameter to deliver the multiphase medium. The chamber may have a second cross-sectional diameter and may be configured to provide a flow path between the inlet and the outlet. The flowmeter may include a device within the chamber and may include a circuit. The device may be configured to move in response to the multiphase medium to dynamically vary an effective cross-sectional area of the chamber and an effective constriction ratio of the flow path. The circuit may include a pressure sensor, a position sensor, and a processor. The pressure sensor may be configured to determine pressure data associated with the multiphase medium. The position sensor may be configured to determine parameter data associated with the device. The parameter data may include data indicative of one or more of a position, a displacement, or an orientation of the device. The processor may be configured to determine a flow rate of the multiphase medium based on the pressure data and the parameter data.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 depicts a block diagram of a system including a Venturi flowmeter including a dynamically variable effective constriction ratio, in accordance with certain embodiments of the present disclosure.

FIGS. 2A-2D depict diagrams of portions of valve units configured to provide a Venturi flowmeter including a dynamically variable effective constriction ratio, in accordance with certain embodiments of the present disclosure.

FIG. 3 depicts a partial block diagram and partial cross-sectional diagram of a valve assembly configured to provide a valve functionality and to provide a Venturi flowmeter including a dynamically variable effective constriction ratio, in accordance with certain embodiments of the present disclosure.

FIG. 4A depicts a graph of cross-sectional area versus time for a Venturi flowmeter including a passive device exposed to a fluid pressure increasing from zero to a maximum pressure, in accordance with certain embodiments of the present disclosure.

FIG. 4B depicts a graph of displacement versus pressure for a Venturi flowmeter including a passive device exposed to a fluid pressure increasing from zero to a maximum pressure, in accordance with certain embodiments of the present disclosure.

FIG. 5 depicts a block diagram of a system including a computing device configured to receive data from one or more of the control system or the variable Venturi flowmeter of FIG. 1 or 3, in accordance with certain embodiments of the present disclosure.

FIG. 6 depicts a flow diagram of a method of determining flow rate data using a variable Venturi flowmeter based on a fluid pressure and a parameter associated with a passive device that alters an effective constriction ratio of the flow path in response to fluid pressure, in accordance with certain embodiments of the present disclosure.

FIG. 7 is a flow diagram of a method of determining flow rate data using a variable Venturi flowmeter based on a differential fluid pressure and a parameter associated with an active device that alters the effective constriction ratio of the flow path in response to an actuator, in accordance with certain embodiments of the present disclosure.

While implementations are described in this disclosure by way of example, those skilled in the art will recognize that the implementations are not limited to the examples or figures described. The figures and detailed description thereto are not intended to limit implementations to the particular form disclosed, but on the contrary, the intention is to cover all modifications, equivalents, and alternatives falling within the spirit and scope as defined by the appended claims. The headings used in this disclosure are for organizational purposes only and are not meant to limit the scope of the description or the claims. As used throughout this application, the work “may” is used in a permissive sense (in other words, the term “may” is intended to mean “having the potential to”) instead of in a mandatory sense (as in “must”). Similarly, the terms “include”, “including”, and “includes” mean “including, but not limited to”.

### DETAILED DESCRIPTION OF ILLUSTRATIVE EMBODIMENTS

Conventional flowmeters are typically tuned to a relatively narrow dynamic range, such as a range that may vary by approximately plus or minus ten percent of an expected flow rate. A Venturi flowmeter may include an inlet having a first diameter that converges to a narrowing feature or throat having a second diameter. The narrowing feature or throat may diverge to an outlet having the same diameter as the inlet. The Venturi flowmeter may cause a differential pressure between the inlet and the outlet, and the flow rate data may be determined from differential pressure measurements. Generally, the Venturi flowmeter may define a constriction ratio between the second diameter and the first diameter. However, at low flow rates, the constriction ratio of a conventional flowmeter may be insufficient to create a pressure differential, since the narrowing feature or throat may not inhibit the fluid flow.

Embodiments of a Venturi flowmeter are described below that is configured to provide a dynamically variable effective constriction ratio to enable determination of flow rate data across a wide range of flow rates. The Venturi flowmeter may include an inlet to receive a fluid (such as a multiphase medium) from a first conduit, an outlet to provide the fluid to a second conduit, and a chamber extending from the inlet to the outlet and defining a constriction. The Venturi flowmeter further includes a device within the chamber that may be configured to move in response to the fluid, passively altering the effective constriction ratio of the flow path. In this implementation, the Venturi flow meter may include a pressure sensor to determine pressure data associated with the fluid in the chamber, a second sensor to determine one or more parameters (one or more of the displacement, the position, or the orientation) associated with the device, and a processor to determine flow rate data associated with the fluid based on the pressure data and the one or more parameters.

In an alternative implementation, an actuator may move the device within the chamber. In such an implementation, the flow rate may be determined based on one or more parameters of the device, first pressure data associated with a pressure at the inlet or the outlet of the flow meter, and a second pressure data associated with the chamber.

In some implementations, a device that is commonly used in a fluid-flow environment (including a multiphase mixture environment) may be adapted to function as a Venturi flowmeter including a dynamically variable effective constriction ratio. For example, a conventional Venturi flowmeter may be adapted to include a piston or other device that may be biased toward the throat of the flowmeter and that may be configured to move along a flow path in a direction of the flow in response to the multiphase mixture to provide the dynamically variable effective constriction ratio.

In another example, a valve unit may be adapted to function as a flowmeter and optionally to also function as a valve. In the valve context, the valve unit may include a passive valve (e.g., globe valve, a ball valve, a flapper valve, a piston valve, an iris valve, or a check disk coupled to a flapper valve or a piston valve) within the chamber. The valve may be biased to contact a valve seat to close a fluid flow path. The valve seat may form a constriction and the valve may move relative to the valve seat in response to the multiphase medium to produce a dynamically variable effective constriction ratio. In this example, the valve unit may include a pressure sensor within the chamber to determine pressure data associated with the multiphase medium and may include a second sensor to determine one or more parameters (one or more of a displacement, a position, or orientation) of the valve. The valve unit may include a processor configured to determine flow rate data based on the pressure data and the one or more parameters. In addition to operating as a flowmeter, the valve unit may limit, restrict, or cease fluid flow from the inlet to the outlet or may be designed to limit flow to a single direction.

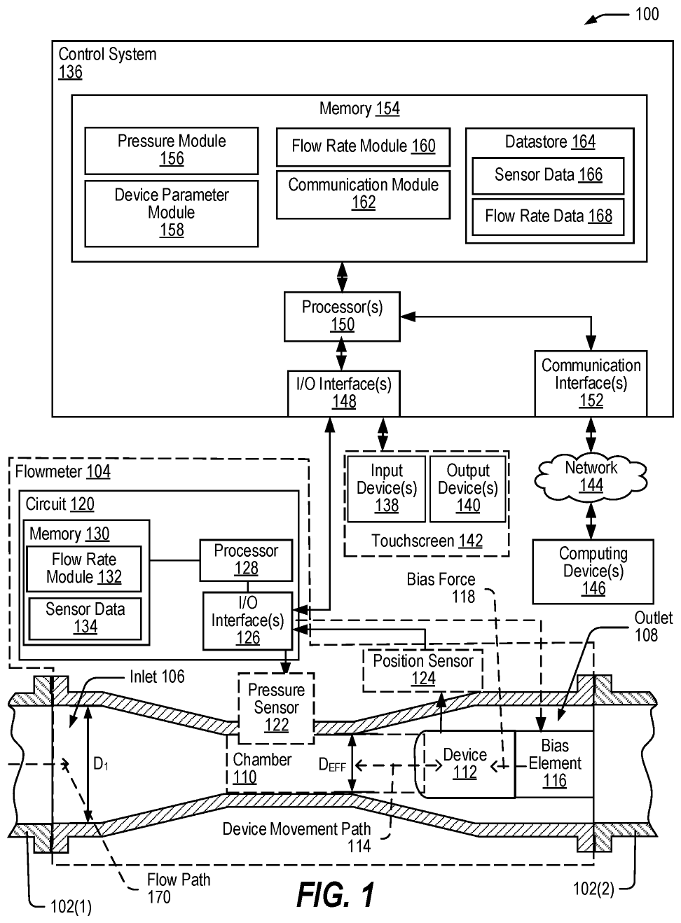

As the multiphase medium moves from the inlet to the outlet through the chamber, the device within the chamber may move in response to the multiphase medium, producing a dynamically variable effective constriction ratio and enabling determination of flow rate data over a wide range of flow rates and flow volumes. One or more parameters (one or more of the position, the displacement, or the orientation) of the device within the chamber may change passively in response to the multiphase medium. The pressure data and one or more parameters of the device may be used to determine the flow rate. An example of a system including a Venturi flowmeter with a dynamically variable effective constriction ratio is described below with respect to FIG. 1.

FIG. 1 depicts a block diagram of a system 100 including a Venturi flowmeter 104 including a dynamically variable effective constriction ratio, in accordance with certain embodiments of the present disclosure. The flowmeter 104 may include an inlet 106 coupled to a first conduit 102(1) to receive a multiphase mixture (water, gas, oil, contaminants, chemicals, and an outlet 108 coupled to a second conduit 102(2). The flowmeter 104 may include a chamber 110 extending between the inlet 106 and the outlet 108. The inlet 106 and the outlet 108 may be approximately the same and may have a cross-sectional diameter (D₁). The flowmeter 104 may include a device 112 positioned within the chamber 110 and that may be configured to move in response to the multiphase medium to alter the effective constriction ratio of a flow path through the chamber 110. The device 112 may cooperate with the sidewalls of the chamber 110 to determine the effective diameter (D_{EFF}) of the chamber 110.

Conventionally, the term “constriction ratio” of a Venturi flowmeter refers to the ratio between a cross-sectional diameter of a throat (or narrow portion) of the flowmeter and the cross-sectional diameter of the inlet or the outlet of the flowmeter. In a conventional Venturi flowmeter, the inlet, the outlet, and the throat are cylindrical, and the constriction ratio does not change, and thus the Venturi flowmeter is typically tuned for accurate measurement of the flow rate within a range of fluid flow rates.

In FIG. 1, the device 112 is positioned at least partially within the chamber 110, which defines the throat or narrowing element. The device 112 is configured to move within the chamber 110 and one or more of the position, displacement, or orientation of the device 112 may change the effective diameter of the constriction. Unlike a conventional Venturi device, the device 112 has a volume that partially obstructs the flow path 170 in three dimensions; however, the resulting volume of the flow path 170 through the construction may be non-cylindrical, and the cross-sectional area that intersects a portion of the device 112 may not be circular. Thus, the size of the opening is an “effective diameter” (D_{EFF}), and the ratio of the effective diameter and the diameter of the inlet 106 (or the outlet 108) is an “effective constriction ratio.”

In an example, the device 112 may occupy a volume within the volume of the chamber 110, and the one or more parameters of the device 112 within the chamber 110 may determine a volumetric constriction of the chamber 110. In particular, the one or more parameters of the device 112 may be indicative of the effective constriction ratio between the inlet 106 (or outlet 108) and the chamber 110. In some implementations, the displacement of the device 112 relative to the narrow portion of the flow path 170 may produce a cross-section that is non-circular, which non-circular cross-section may complicate the constriction ratio because, in this implementation, the constriction ratio is not a comparison of diameters. Instead, the constriction ratio is an effective volumetric constriction ratio, and the movement of the device 112 enables a dynamically variable effective constriction ratio.

In this example, the device 112 is implemented as a passive device that may be biased toward the narrow portion of the chamber 110 by a bias element 116, which may apply a bias force to the device 112 to constrict the flow path 170. The multiphase mixture may cause the device 112 to move in a direction of the flow, and the bias element 116 may bias the device 112 to resist the flow. As a result, the device 112 may move back and forth along a device movement path 114 in response to changes in the pressure of the multiphase mixture. In this example, the movement path 114 of the device 112 may be parallel to or may be the same as a longitudinal axis of the flow path 170. Thus, the multiphase mixture may cause the device 112 to move, changing the effective constriction ratio of the channel 110 and the flow path 170. The bias element 116 may include a spring, a pneumatic element, a hydraulic element, a magnetic element, other elements, or any combination thereof, which may be configured to apply the bias force 118 to the device 112. In some implementations, the bias element 116 may be adjustable in response to a signal from the circuit 120. In an example, the bias element 116 may include an actuator that may adjust a base on which the spring may rest, altering the compression of the spring to alter the bias force 118. In another example, the resistance of bias force 118 of the bias mechanism 116 in response to signals from the circuit 120.

While the flowmeter 104 is depicted as being oriented horizontally, it should be appreciated that the flowmeter 104 may be installed vertically, horizontally, or at a selected angle relative to horizontal or vertical. In a vertical implementation, the bias mechanism 116 may be gravity (by itself) or may include gravity as well as a spring or other mechanism to apply a supplemental bias force 118.

The flowmeter 104 may include sensors including a pressure sensor 122 and a second sensor, such as a position sensor 124. The pressure sensor 122 may be configured to determine pressure data indicative of a pressure of the multiphase medium within the chamber 110. The position sensor 124 may determine one or more parameters (one or more of a position, a displacement, an orientation, or another parameter) associated with the device 112 within the chamber 110.

In some implementations, the flowmeter 104 may include a circuit 120 including one or more input/output (I/O) interfaces 126, which may be coupled to the pressure sensor 122, the position sensor 124, and optionally a control system 136. The circuit 120 may also include a processor 128 coupled to the I/O interfaces 126. The circuit 120 may include a memory 130, which may be a non-volatile memory configured to store data and processor-readable instructions.

The memory 130 may include a flow rate module 132 that, when executed, may cause the processor 128 to determine a flow rate of a fluid flowing along the flow path 170 based on pressure data from the pressure sensor 122 and data associated with one or more parameters (one or more of a passive displacement, a position, an orientation, or other parameter) from the position sensor 124. The memory 130 may also store sensor data 134 together with time and date data.

In some implementations, the processor 128 may communicate flow rate data to the control system 136 via the I/O interface 126. In other implementations, the processor 128 may communicate raw sensor data from the pressure sensor 122 and the position sensor 124 to the control system 136, which may determine the flow rate.

The system 100 may include the control system 136, which may include one or more I/O interfaces 148 configured to communicate with one or more flowmeters 104. The I/O interfaces 148 may be coupled to one or more input devices 138 and one or more output devices 140. The input devices 138 may include one or more of a keyboard, a keypad, a pointer, a stylus, a mouse, a trackpad, a microphone, a scanner, a camera, or other input device. The output devices 140 may include one or more of a display, a printer, a speaker, or other output device. In some implementations, the input device 138 and the output device 140 may be combined in a touchscreen 142, which may display data and receive inputs.

The control system 136 may include one or more processors 150 coupled to the I/O interfaces 148. The control system 136 may include one or more communication interfaces 152, which may communicate with one or more computing devices 146 through a communications network 144. The communications network 144 may include a short-range wireless network, a long-range wireless network, a wired communications network, the Internet, a satellite network, a digital network, other networks, or any combination thereof.

The control system 136 may include a memory 154 coupled to the processor 150. The memory 154 may be configured to store data and to store processor-readable instructions that may control operation of the control system 136 and that may cause the control system 136 to send data to computing devices 146 or to send control signals to one or more flowmeters 104.

The memory 154 may include a pressure module 156 that, when executed, may cause the processor 150 to receive pressure data from one or more flowmeters 104 and to determine the pressure of the fluid within the chamber 110 for each of the one or more flowmeters 104. The memory 154 may include one or more device parameters modules 158 that, when executed, may cause the processor 150 to receive parameter data (such as one or more of position data, orientation data, displacement data, or other data) associated with the device 112 within the chamber 110 of each of the one or more flowmeters 104 and to determine the one or more device parameters based on the parameter data. The memory 154 may include a flow rate module 160 that, when executed, may cause the processor 150 to determine a flow rate of the multiphase medium along the flow path 170 based on the determined pressure and the determined one or more device parameters.

The memory 154 may include one or more communication modules 162 that, when executed, may cause the processor 150 to communicate data to or receive data from one or more flowmeters 104 via the I/O interfaces 148. The communication modules 162 may cause the processor 150 to communicate data to or receive data from one or more computing devices 146 through the network 144. In an example, the communication modules 162 may cause the processor 150 to send flow rate data to one or more computing devices 146 through the network 144.

The memory 154 may include a datastore 164 that may store sensor data 166. The sensor data 166 may include pressure data from pressure sensors 122, parameter data from the position sensors 124, date and time data, as well as identifiers for each of the flowmeters 104 so that the pressure data, parameter data, and date and time data may be correlated to a particular flowmeter 104. The datastore 164 may also store flow rate data 168, which may have been determined using the flow rate module 160 based on the pressure data and the parameter data. In some implementations, the control system 136 may determine the flow rate of the flow of a multiphase medium through the flowmeter 104 based on received pressure data and received parameter data. In other implementations, the control system 136 may receive the pressure data, the parameter data, and the flow rate data from the flowmeter 104 and may store the data in the data store 164.

The device 112 of the flowmeter 104 may be passive, moving in response to the multiphase mixture to provide passive, dynamic adjustment of the effective constriction ratio of the chamber 110. For example, at low pressures, low flow rates, or both, the device 112 may be biased toward the divergence of the chamber 110 by the bias element to reduce the effective diameter (D_{EFF}), narrowing the flow path 170 and increasing the difference between the diameter (D₁) of the inlet 106 and the effective diameter (D_{EFF}) of the chamber 110. At higher pressures, higher flow rates, or both, the device 112 may move away from the divergence of the chamber 110 to increase the effective diameter (D_{EFF}), widening the flow path 170 and decreasing the difference between the diameter (D₁) of the inlet 106 and the effective diameter (D_{EFF}) of the chamber 110.

While the flowmeter 104 in FIG. 1 depicts a chamber 110 that has a diameter that is narrower than the diameter of the inlet 106 or the outlet 108, the device 112 may also work with a reverse implementation in which the chamber 110 has a diameter that is larger than the diameter of the inlet 106 or the outlet 108. In such an implementation, the device 112 may be biased toward the diverging opening adjacent to the inlet 106, leaving a portion of the chamber 110 for recovery of the pressure. Other implementations are also possible.

In some implementations, the bias mechanism 114 may be a spring, and the bias force 118 may be selected by selecting a spring having a desired spring constant. The bias force 118 may be adjusted by replacing the spring with another spring having a selected spring constant. Alternatively, the bias force 118 may be adjusted by compressing or decompressing the spring. Such adjustments to the spring may be performed manually by turning a lever or wheel, electronically by using a motor or an actuator, pneumatically or hydraulically by adjusting a fluid pressure, and so on. Reducing the bias force 118 may allow the device 112 to be more responsive to the multiphase medium, while increasing the bias force 118 may dampen the movement of the device 112.

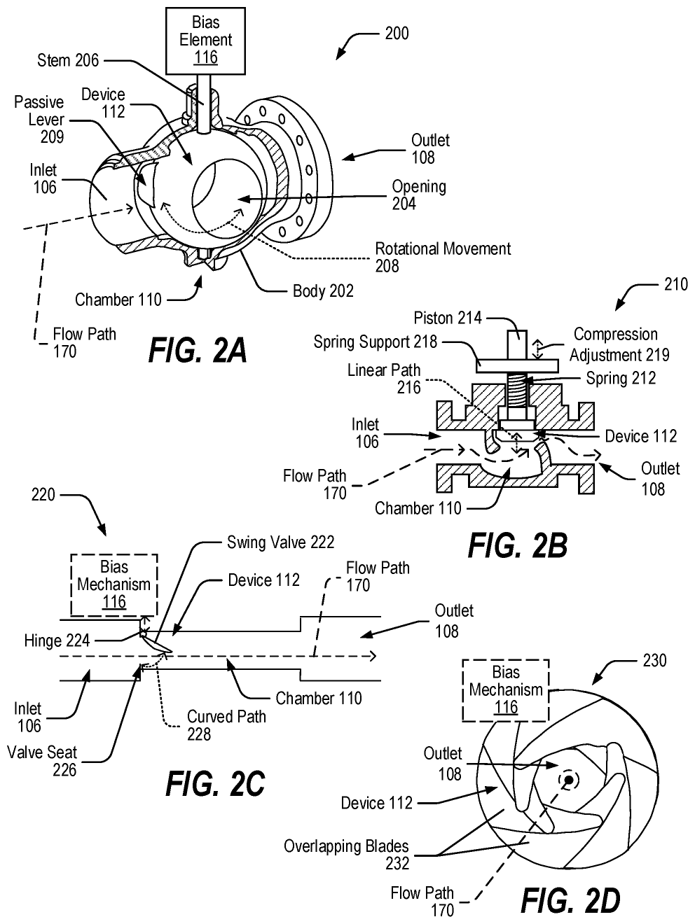

In the illustrated example of FIG. 1, the flowmeter 104 includes an adjustable device 112 within the chamber 110 to vary the effective constriction ratio of the chamber 110 by displacing, positioning, orienting, or otherwise altering a parameter of the device. In this example, the flowmeter 104 may be a Venturi flowmeter that is adapted to include the device 112. It should be appreciated that the flowmeter 104 may be formed from other types of fluid components, which may otherwise perform various functions, such as valve functions. In some implementations, a valve unit may be adapted to operate as the flowmeter 104 in lieu of or in addition to operating as a valve. In an implementation, a valve member of the valve unit may be used as the device 112 to vary an effective constriction ratio of a flow path 170 through a valve seat. The valve member may be implemented as a piston member, a globe member, a ball member, a flapper or swinging member, a check disk member coupled to a piston or flapper or swinging member, an iris valve member (e.g., moveable blades forming a variable opening), or other type of valve member that may move or rotate in response to the multiphase medium to alter the effective constriction ratio of the flow path 170. Some illustrative, non-limiting examples of valve unit-based implementations of the device 112 are described below with respect to FIGS. 2A-2D.

FIGS. 2A-2D depict diagrams of portions of valve units, each of which may include a movable valve that can be used as the device 112 in FIG. 1. In these examples, the flowmeter 104 may be implemented using an existing device, such as a valve, taking advantage of the existing geometry (or modified geometry) and mechanical components to provide a dynamically variable effective constriction ratio. In some implementations, the valve unit may determine a flow rate without performing valve functions. In other implementations, the valve unit may be adapted to operate as a dual-purpose device that provides both flowmeter functionality and valve (or other) functionality, in accordance with certain embodiments of the present disclosure.

In FIG. 2A, a portion of a valve unit 200 is shown that may be adapted to provide flowmeter functionality in lieu of or in addition to valve functionality. The device 112 is a globe valve, which may include a body 202 with an opening 204 that extends through the body 202. The globe valve 200 may include a stem 206 that extends from the body 202, and the body 202 may be configured to rotate about an axis defined by the stem 206 to open or close a flow path 170 as indicated by the arrow 208 labeled “rotational movement”. A bias element 116 may be coupled to the stem 206 to bias the device 112 toward a valve-closed state. The body 202 may include a passive lever 209 that may be configured to convert fluid pressure from the multiphase mixture into torque to turn the device 112 to open the flow path 170 in response to pressure of the multiphase mixture. In a first orientation, the body 202 may be rotated such that a solid portion of the body 202 intersects the flow path 170, closing the flow path 170 to prevent flow of the multiphase mixture. The pressure of the multiphase mixture may apply pressure to the passive lever 209 to turn the body 202 about the stem 206, as represented by the rotational movement 208, to open the flow path 170 at least partially, changing the effective constriction ratio of the flow path 170 from fully closed (as shown) to at least partially open. At different degrees of rotation, the flow path 170 may vary between various states from fully closed to partially obstructed to fully open. As the body 202 is rotated, the effective constriction ratio of the flow path 170 varies.

In some implementations, the circuit 120 or the control system 136 may determine a flow rate of a multiphase mixture flowing through the valve unit 200 based on a pressure data from the pressure sensor 122 (which may be configured to measure a pressure of the multiphase medium at the chamber 110) and an orientation (rotational position or orientation) of the body 202 determined from position data from the position sensor 124, which may be coupled to the stem. In this example, the flow rate may be determined based on the pressure data and the position data.

In FIG. 2B, a portion of a piston-type or plunger-type valve 210 is shown in which the device 112 is the piston 214 that is configured to move in response to pressure from the multiphase medium. In this example, the device 112 may be part of or may be coupled to the end of the piston 214 within the chamber 110. The piston 214 may be biased by a spring 212 into a closed position against a valve seat within the chamber 110. The multiphase medium may flow into the inlet 106, through the chamber 110, and out of the outlet 108 along the flow path 170. The multiphase medium flowing along the flow path 170 may push the piston 214 away from the valve seat as shown by the dashed arrow labeled linear path 216.

The spring 212 may contact a flange or spring support 218, which may provide support for the spring 212 and which may compress the spring 212 to bias the piston 214 toward a closed state. In some implementations, the compression force of the spring 212 may be adjusted by moving the spring support 214 along a compression adjustment path 219. The spring support 214 may include a flange or other component to which one end of the spring 218 may be coupled, and the position of the spring support 218 may be adjusted manually using a screw, a lever, a wheel, or another manual adjustment mechanism or may be adjusted using an actuator, such as an electric motor, a pneumatic device, a hydraulic device, or other device that may move the spring support 218 in response to a signal. By moving the spring support 218 away from the chamber 110, the compression force 118 is reduced and the piston 214 and the device 112 may be more responsive to lower pressures. By moving the spring support 218 toward the chamber 110, the compression force 118 is increased and the piston 214 may be more resistant to pressure, damping the movement of the piston 214 and the device 112.

In this example, the circuit 120 or the control system 136 may determine the flow rate of the fluid based on pressure data from the pressure sensor 122 (located in the chamber 110 or in the outlet 108) and a position of the device 112, which may be determined by a position sensor 124 associated with one or more of the device 112 or the piston 214 coupled to the device 112. The flow rate of the multiphase medium may be determined based on the pressure data and the position of the device 112.

In some implementations, when the pressure differential is below a first threshold pressure level or above a second threshold pressure differential level, the circuit 120 or the control system 136 may send a signal to a device to move the compression adjustment 219 toward or away from the chamber 110. At low pressures that are below the first threshold pressure level, the compression adjustment 219 may be moved away from the chamber 110, reducing the compression on the spring 212. By reducing the compression on the spring 212, the device 112 and the piston 214 may be more responsive to the pressure of the multiphase medium and providing increased granularity with respect to the fluid pressure based on the position of the device 112. At pressures that are above the second threshold pressure level, the compression adjustment 219 may be moved toward the chamber 112, increasing the compression on the spring 212. By increasing the compression on the spring 212, the device 112 and the piston 214 may be less responsive to the pressure of the multiphase medium, damping the movement of the device 112.

In some implementations, the compression adjustment 219 may be moved using an electronic device, such as an actuator, a motor, or another device. In other implementations, the compression adjustment 219 may be performed using a manual lever, a wheel, a screw, or other manual adjustment mechanism. In some implementations, the circuit 120 or the control system 136 may send a control signal to the electronic device to move the compression adjustment 219 by a selected distance. In other implementations, the circuit 120 or the control system 136 may send data to an interface of a computing device of an operator to instruct the operator how to manually move the compression adjustment 219 and by how much.

It should be appreciated that, in some implementations, the spring 212 may be omitted, and the piston 214 and the device 112 may be biased toward the valve seat by gravity. Alternatively, a bias force may include a first bias force applied by the spring 212 and a second bias force supplied by gravity.

While the example of FIG. 2B depicts the device 112 configured to move toward and away from a valve seat (or the chamber 110) along the linear path 216, other implementations are also possible. In an example, the device 112 may be implemented as a swing valve or flapper valve, which may pivot about a hinge. An example of a swing valve implementation of the device 112 is described below with respect to FIG. 2C.

In FIG. 2C, a portion of a flapper-type or swing-type valve 220 is shown in which the swing valve 222 may be configured to pivot about a hinge 224 between an open state (as shown) and a closed state in which the swing valve 222 contacts a valve seat 226. The swing valve 222 is an implementation of the device 112. The swing valve 222 may move along a curved path 228 between the open state and the closed state in contact with the valve seat 226. In this example, the hinge 224 may include a bias mechanism 116 (such as a spring or other element) to bias the swing valve 222 toward the valve seat 226, and the multiphase medium may push the swing valve 222 open, dynamically varying the effective constriction ratio of the flow path 170.

The circuit 120 or the control system 136 may determine the flow rate of the fluid based on pressure data from the pressure sensor 122 associated with inlet 106 or the chamber 110 and a rotational position of the swing valve 222, which may be determined by a position sensor 124 associated with one or more of the swing valve 222 or the hinge 224.

In some implementations, the swing valve 222 may be biased by the bias mechanism, which may be included within the hinge 224 or which may be coupled to the swing valve 222 to apply a selected bias force. The magnitude of the bias force may be adjusted by tightening or loosening the spring within or associated with the hinge 224 or by otherwise adjusting the bias mechanism 116. The bias force may be adjusted manually, such as by tightening a screw or electronically using an actuator. Other implementations are also possible.

In FIG. 2D, a portion of an iris-type valve 230 is shown which may include a plurality of overlapping blades 232 that may be biased toward one another (by a bias mechanism 116, which may include a spring, an actuator, or other component) to close the overlapping blades 232 to reduce the effective constriction of the outlet 108 and that may be pushed open by the flow of the multiphase medium. The overlapping blades 232 are an implementation of the device 112. The blades 232 may be biased toward closure by one or more springs or other bias mechanisms to narrow the outlet 108 and may be pushed open to widen the outlet 108 by the pressure of the multiphase medium. In this example, the flow path 170 is shown as coming out of the page.

In some implementations, the circuit 120 or the control system 136 may determine the flow rate of the multiphase medium based on pressure data from the pressure sensor 122 within the chamber 110 or the inlet 106 and position data corresponding to the positions of the blades 232 determined by one or more position sensors 124.

In some implementations, the bias applied by the springs to close the overlapping blades 232 may be adjustable. In some implementations, the bias force may be adjusted using an actuator to adjust the compression of the spring. In other implementations, the bias force may be adjusted manually by tightening a fastener or otherwise adjusting the spring or a seat to which the spring is mounted.

In each of the examples of FIGS. 2A-2D, the device 112 of FIG. 1 is provided by a valve member, such as a globe member of a globe valve, a piston member, a swing member or flapper member, or moveable blades of an iris valve. In some implementations, the device 112 may be implemented as a piston or other component to provide a flow meter 104 without providing the valve functionality. In an alternative implementation, the device 112 may be implemented as an inflatable device, a telescoping device, or another device that may alter its geometry to change the cross-sectional area of the flow path 146. Other implementations are also possible.

In some implementations, the device 112 may be any type of device that may change shape, position, displacement, or orientation within or at an entrance or exit of a narrowing feature (throat, valve seat, or other constriction) in response to flow from the multiphase medium. The movement of the device 112 may dynamically vary an effective constriction ratio of the flow path 170. Rather than determining a differential pressure, the circuit 120 or the control system 136 may determine the flow rate based on the pressure data from a single pressure sensor 122 and one or more parameters associated with the device 112 determined by a position sensor 124.

In some implementations, a second pressure may be inferred from the displacement of the device 112. In an example, a force applied by a bias mechanism 114 may bias the device 112 (e.g., the valve member) toward the throat or valve seat, and a force applied by the multiphase medium may move the device 112 away from the throat or valve seat. The pressure may be inferred from the displacement of the device 112. In such an example, the flow rate may be determined as a function of a differential pressure between the pressure data determined by the pressure sensor 122 and an inferred pressure determined as a function of the displacement of the device 122. Other implementations are also possible.

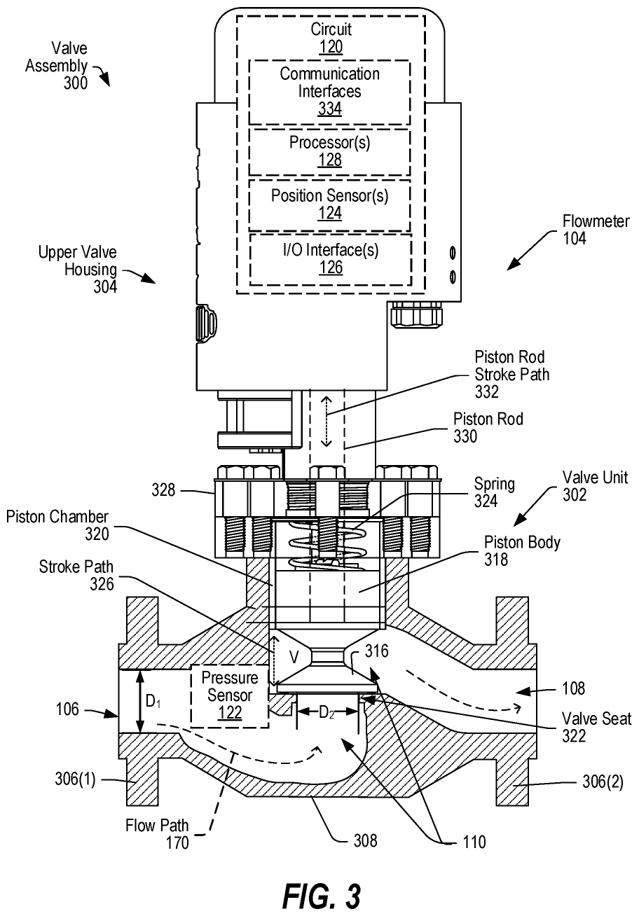

FIG. 3 depicts a partial block diagram and partial cross-sectional diagram of a valve assembly 300 configured to provide a valve functionality and to provide a Venturi flowmeter including a dynamically variable effective constriction ratio, in accordance with certain embodiments of the present disclosure. The valve assembly 300 may include a valve unit 302 coupled to an upper valve housing 304. The valve unit 302 be an implementation of a check valve, which provides a one-way functionality that may allow a multiphase medium to flow through the valve in a first direction (indicated by the flow path 170) and that may prevent the multiphase medium from flowing back in a second direction. The valve unit 302 may include a narrowing constriction comprised of a valve seat 322 and a check disk 316 (i.e., valve member), which may contact the valve seat 322 to close the flow path 170 and which may move away from the valve seat 322 to open the flow path 170. Movement of the check disk 316 toward or away from the valve seat 322 may dynamically vary an effective constriction ratio of a constriction formed by the valve seat 322 and the check disk 316 relative to a cross-sectional diameter of the inlet 106.

The valve unit 302 may include a valve body 308 including a first flange 306(1), which may be coupled to a first conduit, and including a second flange 306(2), which may be coupled to a second conduit. The valve body 308 may include an inlet 106 adjacent to the first flange 306(1), an outlet 108 adjacent to the second flange 306(2), and a chamber 110 extending between the inlet 106 and the outlet 108. The inlet 106 and the outlet 108 may have the same cross-sectional diameter (D₁), which may be substantially equal to the diameter of the first and second conduits to provide a relatively smooth junction from the conduit into the valve unit 302.

Depending on the implementation, the chamber 110 may have a cross-sectional diameter that is the same as the cross-sectional diameter (D₁) of the inlet 106 and the outlet 108 or may have a cross-sectional diameter that is greater than that of the inlet 106 and the outlet 108. However, the valve seat 322 may represent a constriction that has a cross-section diameter (D₂) and that is less than that of the inlet 106, the outlet 108, or the rest of the chamber 110. The check disk 316 may be an implementation of the device 112. The check disk 316 is positioned within the chamber 110 on an outlet side of the valve seat 322. The check disk 316 may be coupled to a piston body 318, which may fit within a piston chamber 320. The valve unit 302 may include a spring 324 to bias the check disk 316 against the valve seat 322, and varying pressure of the multiphase medium and bias force applied by the spring 324 may cause the check disk 316 to move back and forth along a stroke path 326. Movement of the check disk 316 relative to the valve seat 322 may dynamically vary the effective constriction ratio between the effective diameter of the combination of the valve seat 322 and the position of the check disk 316 and the diameter (D₁) of the inlet 106 or the outlet 108. In some implementations, a bias applied by the spring 324 may be adjusted by replacing the spring 324 with a different spring having a different spring constant. Alternatively, the bias may be adjusted by moving a spring seat or plate toward or away from the chamber 110, as described with respect to the compression adjustment 219 in FIG. 2B. In some implementations, the spring seat or plate (now shown) may be located below the cover 328 and may be moved relative to the cover 328 to adjust the compression of the spring 324. Such adjustments may be implemented manually by turning a screw, a lever, or wheel, or other mechanism. Alternatively, such adjustments may be implemented by an actuator or other electrically controlled device.

In some implementations, the spring 324 may be omitted, and the bias force may be gravity, which may operate on the check disk 316, the piston body 318, and the piston rod 330. In such an implementation, gravity may provide sufficient bias force to bias the check disk 316 toward a closed state.

In the illustrated example, the valve seat 322 may have a fixed cross-sectional diameter D₂ that is less than the cross-sectional diameters D₁ of the inlet 106 and the outlet 108. Thus, the valve seat 322 presents a fixed narrowing constriction within the chamber 110 and the check disk 316 may be configured to move relative to the valve seat 322 to provide a dynamically variable effective constriction ratio. In an alternative example, the valve seat 322 may have the same or a larger diameter than that of the inlet 106 and the outlet 108. In such an example, movement of the check disk 316 relative to the valve seat 322 may provide the dynamically variable effective constriction ratio.

In the illustrated example, a piston rod 330 may be coupled to the piston body 318 and may extend through an opening in a cover 328 and into the upper valve housing 304. The upper valve housing 304 of the valve assembly 300 may be configured to secure the circuit 120, which may include the one or more I/O interfaces 126. The one or more I/O interfaces 126 may be coupled to the pressure sensor 122 and the position sensor 124. The circuit 120 may also include the processor 128. In some implementations, the circuit 120 may include one or more communication interfaces 334, which may include transceivers or other modules configured to send data to and to receive data and optionally instructions from the control system 136. In some implementations, the one or more communication interfaces 334 may be included in the I/O interfaces 126.

As the check disk 316 moves, the piston rod 330 may also move along the piston rod stroke path 332. The movement of the check disk 316 within the chamber 110 may cause corresponding movement of the piston body 318 and the piston rod 330. In some embodiments, the processor 128 may determine the position of the check disk 316 based on the position of the piston rod 330 as determined from position data from the position sensor 124.

The flow of the multiphase medium may push the check disk 316 (device 112) open overcoming a bias force applied by the spring 324. The movement of the check disk 316 relative to the valve seat 322 may dynamically vary an effective constriction ratio of the flow path 170 with changes in the flow.

In some implementations, the valve assembly 300 may be configured to operate as both a flow meter to determine a flow rate of a multiphase medium and a check valve to provide one-way flow for the multiphase medium. In a crude oil production environment, the valve assembly 300 may function to prevent the multiphase medium (crude oil mixture of water, oil, entrained gas, and debris) from flowing back down the well bore and to measure the flow rate as the multiphase medium flows through the valve 302. The movement of the check disk 316 may dynamically vary the effective constriction ratio of the valve unit 302, enabling flow rate measurements across a wide range of flow rates. In an example, the valve assembly 300 may be coupled to a conduit to receive a crude mixture that is pumped through the valve assembly 300 by a pump jack. In an example, a pump jack may have a pump cycle or period of six seconds in which each stroke includes a three second portion in which fluid is actively pumped through the valve unit 302 and a three second portion as the pump jack resets. The valve assembly 300 may determine flow rates for a multiphase medium in which the flow volume and pressures vary with the operation of the pump jack because the dynamically variable effective constriction ratio changes with the changes in the flow volume and pressures. In this example, the valve unit 302 may experience a fluid pressure swing between less than 10 pounds per square inch (PSI) and to more than 850 PSI over a period of less than three seconds and then may experience a decrease in the fluid pressure from 850 PSI to 10 PSI. This oscillation in pressure may be repeated with each cycle of the pump jack, e.g., every six seconds. The flow rate of the fluid mixture through the valve unit 302 also varies from a very high flow rate to a very low flow rate as the fluid pressure varies. The dynamically variable effective constriction ratio provided by the valve seat 322 and the movement of the check disk 316 (device 112) may enable flow rate determinations across the entire pump jack cycle, which is currently not possible using a standard fixed-type Venturi device. As previously mentioned, a pressure sensor 122 may determine pressure data indicative of the pressure at the chamber 110, and the flow rate may be determined based on the pressure data and a position of the check disk 316 determined from the position sensor 124.

Conventional Venturi flowmeters may be unable to accurately measure the flow rate across such a wide flow regime because such sensors are typically tuned for accurate measurement within a narrow range (such as a range of flow rates that vary within a ratio of 2 to 1 (e.g., 400 Gallons per Minute (GPM) to 200 GPM). In contrast, the Venturi flowmeter 104 (implemented as a standalone Venturi flowmeter as shown in FIG. 1 or implemented as a valve unit as shown in FIGS. 2A-2D or a valve assembly 300 in FIG. 3) may be used to provide flow rate measurements for a multiphase medium ranging from a low flow rate (no or very little flow, e.g., a trickle) to a high flow rate (e.g., thousands or tens of thousands of units), or low pressures (e.g., no pressure or pressure less than a pressure supplied by a spring to bias the device 112 into a closed state) to high pressures (hundreds or thousands of pounds per square inch). In one non-limiting example, the flowmeter 104 may be used in a crude oil production environment and may be configured to measure fluid flow rates for a crude mixture that has a variable flow that ranges from less than tens of barrels per day to tens of thousands barrels per day (1:10,000 ratio). In general, the Venturi flowmeter 104 in its various implementations can be configured to measure variable fluid flows across wide variations in flows because the device 112 operates to provide a dynamically variable effective constriction ratio based on the flow. In some implementations, the flowmeter 104 may be configured to measure fluid flow rates across a range of fluid flows and pressures that may vary by a factor of 6000 or more. Such wide ranges are not supported by conventional Venturi devices.

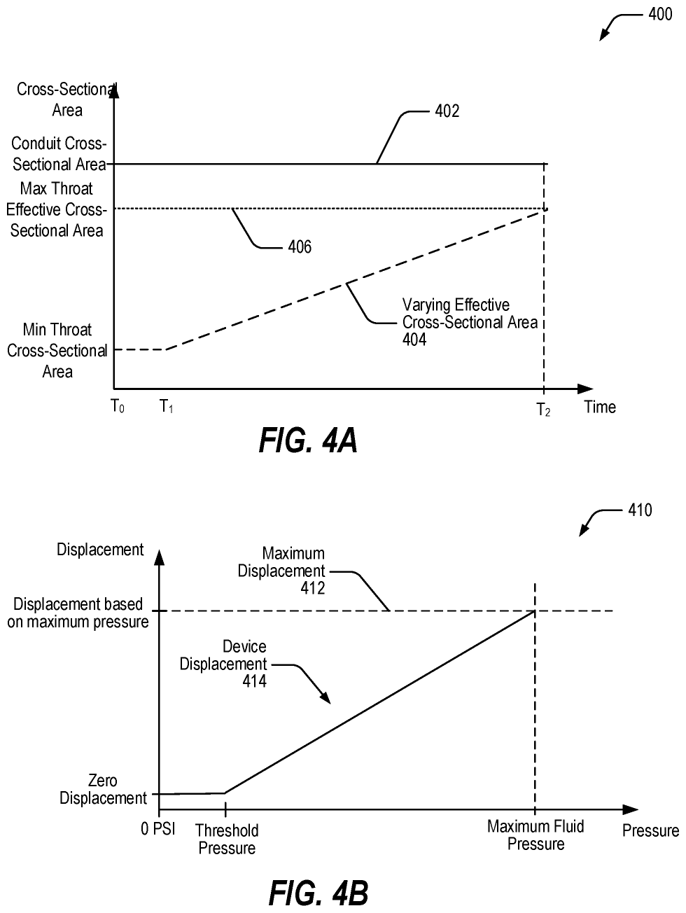

FIG. 4A depicts a graph 400 of cross-sectional area versus time for a flowmeter 104 including a passive device 122 exposed to a pressure of a multiphase medium increasing from zero flow to a maximum pressure, in accordance with certain embodiments of the present disclosure. In the graph 400, the conduit cross-sectional areas are represented by a solid line 402, which may also correspond to the cross-sectional area at the inlet 106 and the cross-sectional area at the outlet 108 of the Venturi flowmeter 104. In this example, it is assumed that the cross-sectional areas of the inlet 106 and the outlet 108 are approximately the same (within margins of error due to manufacturing tolerances) and are approximately equal to the cross-sectional areas of the corresponding conduits 102 to which they are coupled.

In this example, movement of the device 112 in FIG. 1 (or valve 210, 220, 230, or 240 including the device 112 in FIGS. 2A-2D or check disk 316 in FIG. 3) may vary the volume (V) of the chamber 110 (shown in FIGS. 1-3). In this example, the effective cross-sectional area of the chamber 110 may be represented by a dashed line 404. As the device 112 moves, the effective cross-sectional area changes, dynamically changing the effective constriction ratio of the flow path 170. In the example of the valve assembly 300 in FIG. 3, the check disk 316 is depicted in a fully closed position with the check disk 316 and piston body 318 positioned entirely within the chamber 110, and with the check disk 316 in contact with the valve seat 322, closing the flow path 170. As the pressure of the multiphase medium increases to a pressure that exceeds a bias force applied by the spring 324 (or the bias mechanism 114 in FIG. 1), the check disk 316 is moved by the multiphase medium causing the piston body 318 to recede into the piston chamber 320 and out of the chamber 110 and causing the check disk 316 to move away from the valve seat 322, varying the effective constriction ratio of the flow path 146. In this example, the movement of the check disk 316 and the piston 318 away from the valve seat 322 widens the constriction and enables more fluid to flow through the flow path 170 and is reflected by the dashed line 404.

While the graph 400 depicts straight lines, in some implementations, the changing volume of the chamber 110 may be non-linear. In some implementations, the changing volume of the chamber 110 may in-fact be best represented by a curved line, or non-linear relationship, or may be represented best by a log-linear relationship, or combination thereof, depending on the shape of the device 112 (e.g., the shape of the check disk 316 and the piston body 318). Additionally, at least a portion of the check disk 316 may extend into the chamber 110, even when the check disk 316 is fully open, such that the maximum cross-sectional area of the throat (indicated by the dotted line 406) is less than the cross-sectional area of the conduit 402.

In some installations, such as in a crude oil production environment, the multiphase medium flowing through the flowmeter 104 may have a time-varying pressure and flow rate that may be reflected by non-linear movement of the device 112. The position of the device 112 may be varied to allow for measurement of the flow rate across a wide range of fluid flow rates and pressures.

FIG. 4B depicts a graph 410 of displacement versus pressure for a device 112 in FIG. 1 (or check disk 316 in FIG. 3 or valve 200, 210, 220, or 230 in FIGS. 2A-2D) exposed to a fluid pressure (or flow) increasing from zero to a maximum pressure, in accordance with certain embodiments of the present disclosure. In the graph 410, the position of the device 112 changes as generally indicated at 414 between a first position (narrow or closed position) and a second (open position) as the pressure (or flow) increases from the threshold pressure to a maximum fluid pressure (or flow). In some implementations, the changing pressure or flow may in-fact be best represented by a curved line, or non-linear relationship, or may be represented best by a log-linear relationship, or combination thereof. At zero displacement the pressure of the multiphase medium is less than a bias force applied by the bias mechanism 114 or the spring 324. When the pressure of the multiphase medium exceeds the threshold pressure (bias force), the multiphase medium may displace the device 112 or check disk 316, and the magnitude of the displacement may increase as the pressure increases until a maximum pressure is reached. In this example, the maximum displacement 412 is represented as a dashed line. The position sensor 124 may readily determine one or more parameters (one or more of the displacement, the position, or the orientation) of the device 112 or check disk 316 as changes in the flow (pressure or volume) move the device 112 or check disk 316.

In some implementations, the device 112 may remain at the first position (zero displacement) as the pressure from the fluid mixture increases from zero pressure (0 PSI) to a threshold pressure level. The threshold pressure may be determined based on the weight of the device 112 (or check disk 316), a bias force applied by a spring 324 or other bias mechanism 114, other factors, or any combination thereof. Thus, the threshold pressure may vary based on the implementation. Once the pressure exceeds the threshold pressure, the device 112 (or check disk 316) may move within the chamber 110, changing the effective constriction ratio of the flow path 170.

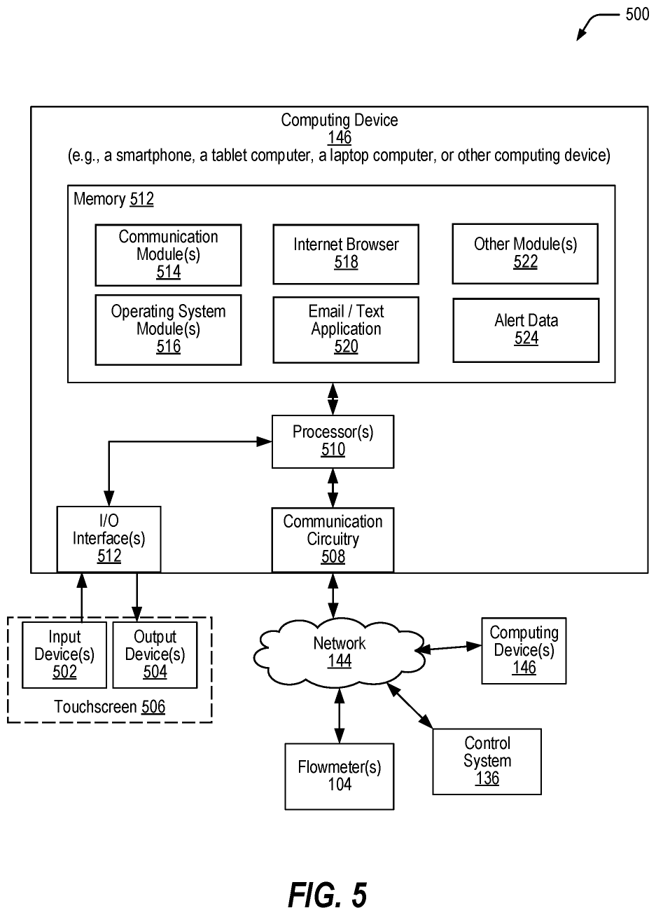

FIG. 5 depicts a block diagram of a system 500 including a computing device 146 configured to receive data from one or more of the control system 136 or the variable Venturi flowmeter 104 of FIG. 1, in accordance with certain embodiments of the present disclosure. The computing device 146 may communicate with one or more variable Venturi flowmeters 104, the control system 136, one or more other computing devices 146, or any combination thereof through the communications network 144. The computing device 146 may include a smartphone, a tablet computer, a laptop computer, another computing device, or any combination thereof.

The computing device 146 may include or may be coupled to one or more input devices 502, such as a keyboard, a mouse (stylus, or other pointer device), a microphone, a scanner, another input device, or any combination thereof. The computing device 146 may include or may be coupled to one or more output devices 504, such as a display, a speaker, a printer, another output device, or any combination thereof. In some implementations, the input device 502 and the output device 504 may be combined in a touchscreen 506.

The computing device 146 may include one or more I/O interfaces 512 configured to couple to the input devices 502 and the output devices 504 (or the touch screen 506). The computing device 146 may further include communication circuitry 508 configured to couple to the network 124. In some implementations, the communication circuitry 508 may include one or more transceivers configured to send and receive data through a communications link. The computing device 146 may include one or more processors 510 coupled to the I/O interfaces 512 and to the communication circuitry 508.

The computing device 146 may include a memory 512 coupled to the processor 510. The memory 512 may be a non-volatile memory, such as a flash drive, a hard disc drive, or another non-volatile memory device. The memory 512 may store data and processor-readable instructions that may cause the processor 510 to perform one or more operations.

The memory 512 may include one or more communication modules 514 that may cause the processor 510 to receive data from one or more of the variable Venturi flowmeter 104 (implemented as the flowmeter 104 in FIG. 1, the valves 200, 210, 220, or 230 of FIGS. 2A-2D, or the valve assembly 300 in FIG. 3) or the control system 136. The communication modules 514 may cause the processor 510 to communicate requests, data, alerts, or other information to the control system 136.

The memory 512 may include one or more operating system modules 516 that may cause the processor 510 to perform various computer operations. The memory 512 may include an Internet browser application 518 that may cause the processor 510 to access web pages over the Internet and to present a graphical interface including data and user-selectable controls that may be accessed by a user to view data.

The memory 512 may include one or more of an email or text application 520 that may be configured to receive messages and to present the messages to a display. Such messages may include alerts, flow rate data, or other data. The memory 512 may include one or more other modules 522 that may cause the processor 510 to perform a variety of operations.

In some implementations, the memory 512 may store alert data 524. The alert data 524 may include data received from one or more of the control system 136 or the flowmeter 104. In some implementations, the alert data 524 may be presented within a graphical interface rendered by the Internet browser application 518 or in another application, such as the email or text message application 520. Other implementations are also possible.

In some implementations, one or more of the control system 136 or the flowmeter 104 may communicate data indicative of a flow rate through the flowmeter to the computing device 146. The computing device 146 may receive the flow rate data and may present the flow rate data to a display within a graphical interface produced by the Internet browser application 518 or the email or text message application 520. Other implementations are also possible.

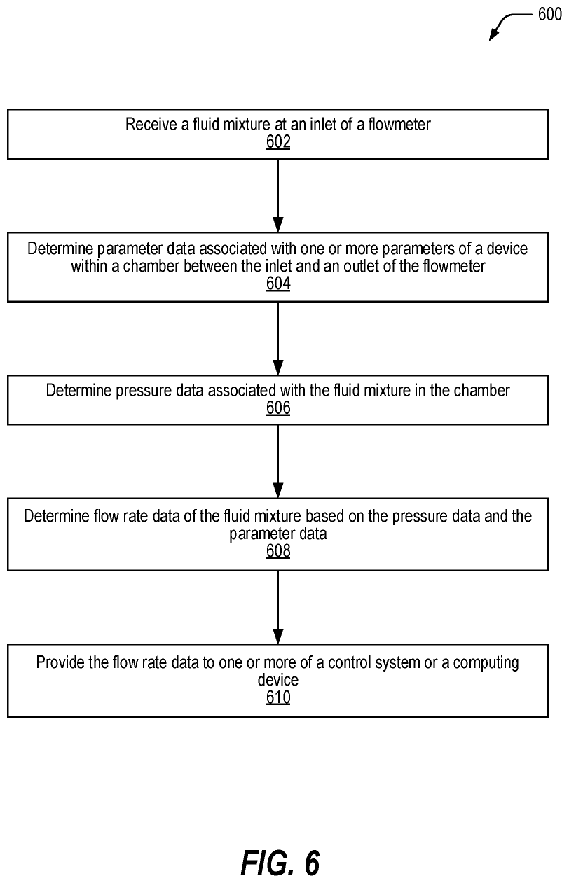

FIG. 6 depicts a flow diagram of a method 600 of determining flow rate data using the variable Venturi flowmeter 104 including a passive device 112 where the flow rate data is determined based in part on a parameter associated with displacement of the passive device 112, in accordance with certain embodiments of the present disclosure. In an example, the passive device 112 may be implemented as a piston or other movable device within the flow path 170. In some implementations, the passive device 112 may include a valve member of a value unit, such as a piston member, a flapper or swinging member, a globe member, an iris member (such as a plurality of blades that may form a variable opening), a check disk coupled to a piston or flapper or swing member, or other valve member that moves in response to pressure of the multiphase medium, thereby dynamically altering the effective constriction ratio of the flow path 170.

At 602, the method 600 may include receiving a multiphase medium at an inlet 106 of the flowmeter 104. The multiphase medium may include a crude oil mixture (oil, water, gas, and contaminants), a liquid fuel, water, a solution, or another fluid. The multiphase medium may be forced into the inlet 106 by a pump, such as a pump jack, a continuous flow pump, or another type of pump or from a well or other source that is under continuous bias pressure and is free flowing. In other implementations, the multiphase medium may be provided to the inlet 106 from a fluid source, such as a water tank, a fuel tank, or another source.

At 604, the method 600 may include determining parameter data associated with one or more parameters of the device 112 within the chamber 110 between the inlet 106 and an outlet 108 of the flowmeter 104. The one or more parameters may include one or more of the displacement, the position, the orientation, or other parameters associated with the device 112. The one or more parameters may be determined using a position sensor 124. It should be appreciated that the effective cross-sectional area of the chamber 110 may vary as a function of the displacement of the device 112, thereby dynamically altering an effective constriction ratio of the flow path 170.

At 606, the method 600 may include determining pressure data associated with the multiphase medium in the chamber 110. The apparatus may include a pressure sensor 122 configured to determine the pressure data within the chamber 110.

At 608, the method 600 may include determining flow rate data of the multiphase medium based on the pressure data and the parameter data. In an example, the device 112 may be biased toward a closed position (such as by a spring), and the amplitude of the fluid pressure may determine the displacement of the device 112 within the chamber 110. By using displacement of the device 112 in conjunction with the pressure measurement to determine the flow rate, the flow rate may be determined across a wide range of flows, since the displacement of the device 112 can be determined based on the volume and pressure of the flow. The displacement of the device 112 may alter the effective constriction ratio of the flow path 170 within the chamber 110 to provide a variable throat or neck that can be used to determine the flow rate across a wide range of flow volumes, rates, and pressures.

At 610, the method 600 may include providing the flow rate data to one or more of the control system 136 or the computing device 146. The flow rate data may indicate the flow rate through the flowmeter 104.

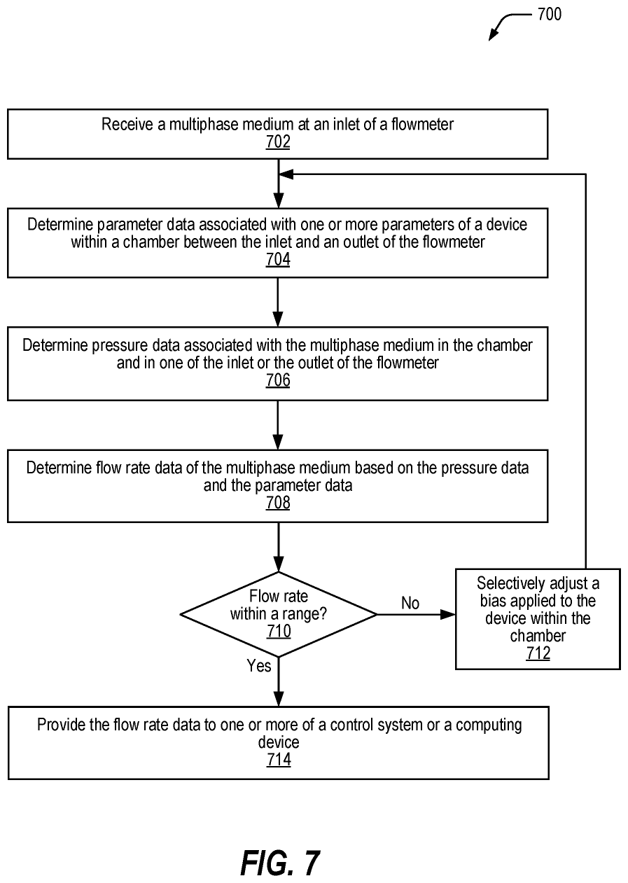

While the example in FIG. 6 assumes a passive device 112 that may be displaced by the fluid flow, manual adjustments or actuator-based adjustments are also possible. For example, it may be desirable to adjust a spring to alter the bias force applied by the spring. At low flow rates, the spring force may be adjusted to reduce the bias applied to the device 112. At higher flow rates, the spring force may be adjusted to increase the bias applied to the device 112. This type of adjustment may be used to tune the responsiveness of the device 112 for extremes or for characteristics of a particular flow medium. An example is described below with respect to FIG. 7 that provides a dynamically variable Venturi flowmeter 104 based on adjustments provided by a control system 136 or from a manual control mechanism.

FIG. 7 is a flow diagram of a method 700 of determining flow rate data using a variable Venturi flowmeter 104 including a device 112 within the chamber 110 where the flow rate data is determined based in part on a parameter associated with the device 112, in accordance with certain embodiments of the present disclosure. At 702, the method 700 may include receiving a multiphase medium at an inlet 106 of the variable Venturi flowmeter 104. The multiphase medium may include a crude mixture of oil, gas, water, debris, another fluid, or any combination thereof. Alternatively, the multiphase medium may include a fuel, a fluid solution, water, another liquid, or any combination thereof.

At 704, the method 700 may include determining one or more parameters associated with the device 112 within a chamber 110 between the inlet 106 and the outlet 108 of the flowmeter 104. The device 112 may be moved within the chamber 110 in response to the pressure of the multiphase medium. A position sensor 124 may be configured to determine one or more of a position, a displacement, an orientation, or another parameter of the device 112 within the chamber 110. The position sensor 124 may include a capacitive sensor, an inductive sensor, a resistive sensor, a Hall-effect sensor, other sensor, or any combination thereof.

At 706, the method 700 may include determining pressure data associated with the fluid mixture within the chamber 110. In an example, a pressure sensor 134 may measure the fluid pressure within the chamber 110 in which the device 112 moves. The pressure sensor 134 may include a capacitive sensor, a resistive sensor, or another sensor configured to determine the fluid pressure.

At 708, the method 700 may include determining flow rate data of the multiphase medium based on the pressure data and the parameter data. In some implementations, the one or more parameters of the device 112 may be indicative of the pressure. Moreover, the variable position of the device 112 within the chamber 110 may determine a dynamically variable effective constriction ratio between the effective cross-sectional diameter of the chamber 110 and to the cross-sectional diameter of the inlet 106, providing a differential pressure between the inlet 106, the outlet 108, and the chamber 110. In a passive implementation, the position of the device 110 may be determined by the fluid pressure, and the changes in position of the device 112 may alter the effective constriction ratio of the flow path 170, producing a variable Venturi flowmeter 104 that may be used to determine the flow rate across a wide range of flow volumes and pressures.

At 710, the method 700 may determine whether the flow rate is within a predetermined range. The range may represent a range of flow rate values within which the flowmeter 104 may measure the fluid flow based on the current position of the device 112 within the chamber 110. In an example, if the cross-sectional area is too large (such as when the fluid flow rate is very low), the device 112 may not impede the fluid flow, indicating that the flow rate is outside of the range of the variable Venturi flowmeter 104. In an alternative example, if the pressure of the fluid is insufficient to move the device 112, the bias force applied by the spring 324 or other bias mechanism 114 may be outside of a range.

At 710, if the flow rate is not within the range (either below or above the range), the method 700 may advance to 712 and the method 700 may include selectively adjusting a bias applied to the device 112 within the chamber 110. In an example, the range to which the flow rate is compared in 710 may be narrower than the range over which the flowmeter 104 may accurately measure the flow rate. The range comparison at 710 may be used to adjust the bias force applied to the device 112, such as by adjusting the compression of the spring 324 or by adjusting the force applied by the bias mechanism 114. Such adjustments may tune the variable Venturi flowmeter 104 to be more or less responsive to the pressure to determine the flow rate. The bias may be adjusted by an operator by turning a manual component, such as a screw, a lever, or other component. A message sent to a computing device 146 may include instructions for adjusting the bias. Alternatively, the flowmeter 104 may include an actuator responsive to control signals from the circuit 120 or the control system 136 to adjust the bias force. The method 700 may then return to 704 to determine the parameter data.

Returning to 710, if the flow rate is within the range, the method 700 may include providing the flow rate data to one or more of the control system 136 or the computing device 146, at 714. The flow rate data may include date and time data as well as fluid flow data, data about the flowmeter 104 (such as an identifier), other data, or any combination thereof. In some implementations, the output may include data provided within a graphical interface, which may be provided to a display device or rendered within an Internet browser application. Other implementations are also possible.

The variable Venturi flowmeter 104 described with respect to FIGS. 1-7 may be implemented to provide dual functionality, such as a flowmeter functionality and a valve functionality. In some implementations, the variable Venturi flowmeter 104 may be implemented as a multiphase flowmeter and may be configured to determine the fluid flow rate as well as the cut of gas, water, and other elements within the fluid using additional sensors.

In the examples above, the variable Venturi flowmeter 104 may include a device that may be configured to move in response to a multiphase medium to dynamically alter an effective constriction ratio of the flow path 170. This dynamically variable constriction ratio is provided by a device 112 that moves in response to the multiphase medium and that can be used to determine the flow rate of the multiphase medium across a wide range of flow rates and pressures.

In one implementation, a pressure sensor 122 may be provided in the chamber 110 within which the variable Venturi flowmeter. The processor 128 of the circuit 120 may receive pressure data from the pressure sensor 122 and may receive parameter data corresponding to one or more parameters of the device 112 from the position sensor 124. The processor 128 may be configured to determine a flow rate of the fluid mixture based on the pressure data and the parameter data.

In some implementations, the processor 128 may calculate the pressure in the chamber 110 based in part on the resistance of the device to movement. In a valve assembly implementation, the force of the spring 324 and the weight of the check disk 316, the piston body 318, and the piston rod 330 may define a pressure threshold. To move the check disk 316, the pressure of the fluid in the chamber 110 has to exceed the compression force applied by the spring 324 and the sum of the weights in order to move the check disk 316. In some implementations, since the pressure threshold is known, the fluid pressure may be determined from the displacement of the device 112. Further, a differential pressure may be determined based on a determined displacement of the device 112 and pressure data from the pressure sensor 122. Thus, the flow rate may be determined based on the measured pressure as determined by the pressure sensor 122 and the displacement of the device 112 as determined by the position sensor 124.

In conjunction with the systems, methods, and devices described herein with respect to FIGS. 1-7, embodiments of a variable Venturi flowmeter 104 includes a device 112 within a flow path between the inlet and the outlet that may be configured to move in response to the multiphase medium to dynamically vary the effective constriction ratio of the flow path 170. A pressure sensor 122 determines pressure data of the multiphase medium within the flow path, and a position sensor 124 determines parameter data corresponding to one or more parameters of the device 112. The one or more parameters may include one or more of the displacement, the position, the orientation, or other parameter of the device 112. A processor of a circuit 120 or the control system 136 may determine the flow rate based on the fluid pressure and the one or more parameters.

In some implementations, the variable Venturi flowmeter may include an inlet 106, an outlet 108, a chamber 110, and a device within the chamber 112 that may be configured to dynamically vary the effective constriction ratio of the flow path 170 through the flowmeter 104. The inlet 106 may be coupled to a first conduit and configured to receive a multiphase medium, which may include one or more of oil, gas, water, a crude oil mixture, a liquid solution, or another solution. The outlet 108 may be coupled to a second conduit and may be configured to deliver the fluid mixture to the second conduit. The chamber 110 may extend between the inlet 106 and the outlet 108. The device 112 may be positioned at least partially within the chamber 110 and may be configured to move in response to the multiphase medium to dynamically vary the effective constriction ratio of the flow path 170. The variable Venturi flowmeter 104 may include a pressure sensor 122 to determine pressure data of the multiphase medium within the chamber 110 and may include a second sensor (position sensor 124) to determine one or more parameters associated with the device 112. The one or more parameters may be indicative of one or more of the position, the orientation, the displacement, or other parameter of the device 112 within the chamber 110.

In a passive implementation, the device 112 may be configured to move in response to the fluid passing through the variable Venturi flowmeter 104. The fluid pressure may alter one or more of the position, the orientation, the displacement, or other parameter of the device 112 within the chamber 110, thereby dynamically varying the effective constriction ratio of the flow path 170 through the flowmeter 104. A circuit 120 of the flowmeter 104 (or the control system 136) may determine a flow rate based on pressure data from the pressure sensor 122 and parameter data from the position sensor 124. The parameter data may be indicative of one or more of the displacement, the position, the orientation, or other parameter of the device 112. The variable Venturi flowmeter 104 may be a standalone, single function device configured to determine the flow rate based on the pressure data and the parameter data. In some implementations, the passive implementation of the device 112 may be configured to operate as a multi-phase flowmeter.

In other implementations, the variable Venturi flowmeter 104 may be incorporated into a multi-function device. In one example, the multi-function device may include a multiphase flowmeter configured to determine the flow rate of the multiphase medium and to determine volume of water, gas, oil, and other components in the multiphase medium.

In another example, the multi-function device may include a valve, or other device, and may be configured to measure the flow rate and to perform the valve function or other function. For example, a valve assembly 300 may be adapted to operate as a check valve to prevent backflow of a fluid from the outlet 108 to the inlet 106. The valve assembly 300 may also include the pressure sensor 134 and a position sensor 136 coupled to a valve member, such as a check disk 316 of a valve unit, a swing or flapper member of a valve unit, a globe member of a valve unit, a moveable piston member, another valve member, or other type of adjustable component. The movable valve member of the valve unit may operate as the device 112 to dynamically vary the effective constriction ratio of the flow path 170. The valve assembly 300 may determine pressure data using the pressure sensor 122 and parameter data associated with the device 112 (such as the check disk 316) using the position sensor 124. The parameter data may include one or more of the position, the displacement, the orientation, or other parameter of the device 112 (i.e., the valve member). The valve assembly 300 may include a circuit 120 that may be configured to determine the flow rate of the multiphase medium based on the pressure data and the parameter data.

The device 112 (or check disk 316) may be configured to move passively in response to pressure of the multiphase medium. A spring or other bias mechanism may be configured to apply a bias force to the device 112. The bias force may be adjusted by replacing the spring or by altering a compression of the spring, such as by moving a spring seat relative to the chamber or by tightening the spring. The bias force may be adjusted to make the device 112 more or less responsive to the pressure of the multiphase medium. The circuit 120 may receive pressure data from a pressure sensor 122 and parameter data indicative of one or more parameters of the device 112 from the position sensor 124. The one or more parameters may indicate one or more of the position, the displacement, the orientation, or other parameter of the device 112. The circuit 120 may determine the flow rate of the multiphase medium based on the pressure data and the parameter data and may send data indicative of the flow rate to one or more of a control system 136 or a computing device 146. Other implementations are also possible.

In some implementations, the circuit 120 may determine the pressure data from the pressure sensor 122 and the parameter data from the position sensor 124 and may communicate the pressure data and the parameter data to the control system 136, which may determine the flow rate. In some implementations, the control system 136 may determine the cut of oil, gas, water, and other components in the multiphase medium based in part on the pressure data and the parameter data. In some implementations, the control system 136 may send data to one or more computing devices 146, which data may include information related to one or more of the flow rate, the cut of oil, gas, water, and contaminants, or an error event that may indicate that the variable Venturi flowmeter 104 may be in need of service. Other implementations are also possible.

Although the present invention has been described with reference to preferred embodiments, workers skilled in the art will recognize that changes may be made in form and detail without departing from the scope of the invention.

What is claimed is:

1. A flowmeter comprising:
an inlet configured to couple to a first conduit to receive a flow of a multiphase medium;
an outlet configured to couple to a second conduit to deliver the multiphase medium;
a chamber extending between the inlet and the outlet and providing a flow path between the inlet and the outlet;
a device within the chamber, the device configured to move in response to the multiphase medium to dynamically vary an effective constriction ratio of the flow path; and
a circuit configured to determine a flow rate of the multiphase medium based on the effective constriction ratio.

2. The flowmeter of claim 1, wherein the circuit comprises:
at least one pressure sensor configured to determine pressure data associated with the multiphase medium; and
a processor configured to determine the flow rate of the multiphase medium based on the pressure data.

3. The flowmeter of claim 1, wherein the circuit comprises:
a pressure sensor configured to determine pressure data associated with the multiphase medium;
a position sensor configured to determine parameter data indicative of one or more parameters of the device, the one or more parameters including one or more of a position, a displacement, or an orientation of the device; and
a processor configured to determine the flow rate of the multiphase medium based on the pressure data and the parameter data.

4. The flowmeter of claim 1, further comprising a bias mechanism configured to apply a bias force to the device to resist the flow.

5. The flowmeter of claim 4, the bias mechanism is adjustable to alter the bias force applied to the device.

6. The flowmeter of claim 1, wherein:
the flow meter comprises a valve unit; and
the device comprises a valve member of the valve unit, the valve unit comprises the valve configured to move toward or away from a valve seat of the valve unit in response to the multiphase medium; and
the circuit comprising:
a pressure sensor configured to determine pressure data of the multiphase medium within the chamber;
a position sensor configured to determine parameter data associated with the valve, the parameter data indicative of one or more of a displacement, a position, or an orientation of the valve within the chamber; and
a processor coupled to the pressure sensor and the position sensor, the processor configured to determine a flow rate of the multiphase medium based on the pressure data and the parameter data.

7. The flowmeter of claim 1, wherein:
the inlet has a first cross-sectional diameter;
the outlet has the first cross-sectional diameter of the inlet;
the chamber has a second cross-sectional diameter; and
the device moves within the chamber to vary the second cross-sectional diameter to produce an effective cross-sectional diameter in response to the multiphase medium.

8. The flowmeter of claim 7, wherein the second cross-sectional diameter is larger than the first cross-sectional diameter.

9. A flowmeter comprising:
an inlet having a first cross-sectional diameter and configured to couple to a first conduit having the first cross-sectional diameter to receive a flow of a multiphase medium;
an outlet having the first cross-sectional diameter and configured to couple to a second conduit having the first cross-sectional diameter to deliver the multiphase medium;
a chamber having a second cross-sectional diameter and extending between the inlet and the outlet, the chamber configured to provide a flow path between the inlet and the outlet;
a device within the chamber, the device configured to move in response to the multiphase medium to dynamically vary an effective cross-sectional area of the chamber and an effective constriction ratio of the flow path; and
a circuit configured to determine a flow rate of the multiphase medium based on the effective constriction ratio.

10. The flowmeter of claim 9, wherein the chamber defines a second cross-sectional diameter is larger than the first cross-sectional diameter.

11. The flowmeter of claim 9, wherein the circuit comprises:
at least one pressure sensor configured to determine pressure data associated with the multiphase medium; and
a processor configured to determine the flow rate of the multiphase medium based on the pressure data.

12. The flowmeter of claim 9, wherein the circuit comprises:
a pressure sensor configured to determine pressure data associated with the multiphase medium;
a position sensor configured to determine parameter data indicative of one or more parameters of the device, the one or more parameters including one or more of a position, a displacement, or an orientation of the device; and
a processor configured to determine the flow rate of the multiphase medium based on the pressure data and the parameter data.

13. The flowmeter of claim 9, further comprising a bias mechanism configured to apply a bias force to the device to resist the flow.

14. The flowmeter of claim 13, the bias mechanism is adjustable to alter the bias force applied to the device.

15. The flowmeter of claim 9, wherein:
the flowmeter comprises a valve unit; and
the device comprises a valve member of the valve unit; and
wherein the circuit comprises:
a pressure sensor configured to determine pressure data of the multiphase medium within the chamber;
a position sensor configured to determine parameter data associated with the valve, the parameter data indicative of one or more of a displacement, a position, or an orientation of the valve within the chamber; and
a processor coupled to the pressure sensor and the position sensor, the processor configured to determine a flow rate of the multiphase medium based on the pressure data and the parameter data.

16. A flowmeter comprising:
an inlet having a first cross-sectional diameter and configured to couple to a first conduit having the first cross-sectional diameter to receive a flow of a multiphase medium;
an outlet having the first cross-sectional diameter and configured to couple to a second conduit having the first cross-sectional diameter to deliver the multiphase medium;
a chamber having a second cross-sectional diameter and extending between the inlet and the outlet, the chamber configured to provide a flow path between the inlet and the outlet;
a device within the chamber, the device configured to move in response to the multiphase medium to dynamically vary an effective cross-sectional area of the chamber and an effective constriction ratio of the flow path; and
a circuit comprising:
a pressure sensor configured to determine pressure data associated with the multiphase medium;
a position sensor configured to determine parameter data associated with the device and indicative of the effective constriction ratio, the parameter data including data indicative of one or more of a position, a displacement, or an orientation of the device; and
a processor configured to determine a flow rate of the multiphase medium based on the pressure data and the parameter data.

17. The flowmeter of claim 16, wherein:
the flow meter comprises a valve unit including the inlet, the outlet, and the chamber;
the device comprises a valve member of a valve unit, the valve is configured to move toward or away from a valve seat within the chamber of the valve unit in response to flow of the multiphase medium.

18. The flowmeter of claim 16, further comprising:
a bias mechanism configured to apply a bias force to the device to resist the flow; and
wherein the bias mechanism is adjustable to alter the bias force applied to the device.

19. The flowmeter of claim 16, wherein:
the inlet has a first cross-sectional diameter;
the outlet has the first cross-sectional diameter of the inlet;
the chamber has a second cross-sectional diameter; and
the device moves within the chamber to vary the second cross-sectional diameter to produce an effective cross-sectional diameter in response to the multiphase medium.

20. The flowmeter of claim 19, wherein the second cross-sectional diameter is larger than the first cross-sectional diameter.
